(19) United States
(12) Patent Application Publication
(10) Pub. No.: US 2003/0182408 A1
(43) Pub. Date: Sep. 25, 2003

(54) Load test system for a server and method of use

(76) Inventor: Qinglong Hu, Morgan Hill, CA (US)

Correspondence Address: SAWYER LAW GROUP, P.O. Box 51418, Palo Alto, CA, 94303, US

(21) Appl. No.: 10/077,237

(22) Filed: Feb. 15, 2002

(51) Int. Cl. G06F 9/44; G06F 15/173

(52) U.S. Cl. 709/223; 703/21

(57) ABSTRACT

A method and system for load testing a server is disclosed. The method and system includes providing at least one virtual user, each of which simulates one client device, a main thread to emulate a plurality of user sessions between the at least one virtual user and the server, wherein each user session includes at least one request/response pair, and generating a plurality of subthreads from the main thread, wherein each subthread emulates one of the plurality of user sessions. The method and system further includes, building in each virtual user a message that includes a request extracted from the at least one request/response pairs in the one user session, and transmitting that message to the server.

The method and system according to the preferred embodiment of the present invention easily creates a system load, quickly composes multi-user test scenarios, and automatically runs load testing. One aspect of the method and system of the present invention supports a stateful model, i.e., messages can be built based on previous synchronization user sessions with the server, because information that is to be used in subsequent messages or user sessions is stored and updated in a configuration file. Messages are then built to include information stored in the configuration file. In another aspect of the present invention, security information is also stored in the configuration file so that the subthread can emulate secure communications between the virtual user and the server.

### FIELD OF THE INVENTION

The present invention relates generally to computer systems and, more particularly, to a method and system for load testing a server.

### BACKGROUND OF THE INVENTION

With the proliferation of mobile handheld devices, such as personal digital assistants (PDAs) and cellular phones, new applications have been developed to provide mobile computing. Whereas at one time these handheld devices, referred to as “thin devices,” offered limited computing support for users, today thin devices allow users to access the Internet to retrieve and send electronic mail, or to browse. Moreover, a user can utilize her thin device to access data stored in a database while she is away from her office. For example, DB2 Everyplace® developed by International Business Machines Corporation, Armonk, N.Y., allows data from a database to be delivered to thin devices, and also lets the mobile user access and perform updates to the database using her thin device. In other words, data synchronization between the database and the thin device is performed.

FIG. 1 illustrates a block diagram of a web-based system 10 for data synchronization between a database 20 and a plurality of mobile clients 50a-50n. As is shown, each client 50a-50n includes a database 60a-60n. When a client 50a needs to access the database 20, the client 50a communicates via a network 25 to a web server 30, such as a Webspheret ® developed by IBM. The web server 30 includes a sync server 40, such as an IBM DB2 Everyplace®, Sync Servers, which effectively allows the client 50a to communicate with the database 20. The sync server 40 also performs security functions such as encrypting its response to ensure secured communication between the client 50a and the database 20.

In order to implement the client/server system 10 successfully, load testing of the sync server 40 must be performed under a variety of user workloads so that performance parameters, such as response times, can be predicted. Currently, functional testing is performed manually, e.g., real client devices and live users submit requests to the server to test the functional capacity of the server, or an emulator is executed on a personal computer. Manual approaches are expensive and inefficient, and emulators require large computer resources. Both require live testers to initiate and run the tests. Load testing is not feasible because the number of live testers needed to conduct an adequate load test and the effort to coordinate them is too costly and labor intense.

While several web-based load testing applications are available, e.g., Microsoft's Web Application Stress (http://webtool.rte.microsoft.com/), these applications are unsuitable for load testing the client/server system of FIG. 1. First, web-based load testing applications are designed for interactions between a web server and a client browser. Generally, a browser merely displays information (e.g., wage pages) to a user and does not have the ability to process information. Thus, web-based load testing applications cannot test more complicated interactions where the client is more sophisticated than a browser. Second, those existing load testing applications that are designed for user sessions between server and client, are designed for a simple client/server architecture, where the client is a traditional personal computer or laptop having large resources, such as high CPU speed and memory capacity. Thus, only one request/response pair between the client and server is necessary. In contrast, thin devices have limited resources, in particular, bandwidth and memory capacity. The thin device client may not be able to consume a large trunk of message sent by the server. Accordingly, the server is required to send multiple messages to the client, i.e., one user session usually requires at least one request/response pair. Existing load testing applications are not designed to handle multiple request/response pairs between the client and server during a single user session.

Third, existing load testing applications are “stateless,” i.e., a current user session has no influence on a subsequent user session. While this may not be relevant for the simple client/server exchanges, it is relevant for more complicated client/server exchanges where a previous user session can have an impact on subsequent user sessions between a client and the server.

Finally, existing load testing applications do not incorporate secured communications between the client and server. In order to test network security, the load testing application must be able to receive and transmit security information particular to each client. Otherwise, the client will be treated as an intruder and prevented from communicating with the server.

Accordingly, a need exists for a load testing tool that can simulate multiple concurrent client devices, including thin devices, to test a server's throughput and response time. The tool should be stateful, and support multiple request/response pairs, client authentication, and secured communications. Moreover, the tool should be lightweight, e.g., requiring minimal human and computing resources, and should analyze test results automatically. The present invention addresses such a need.

### SUMMARY OF THE INVENTION

A method and system for load testing a server is disclosed. The method and system includes providing at least one virtual user, each of which simulates one client device, a main thread to emulate a plurality of user sessions between the at least one virtual user and the server, wherein each user session includes at least one request/response pair, and generating a plurality of subthreads from the main thread, wherein each subthread emulates one of the plurality of user sessions. The method and system further includes, building in each virtual user a message that includes a request extracted from the at least one request/response pairs in the one user session, and transmitting that message to the server.

The method and system according to the preferred embodiment of the present invention easily creates a system load, quickly composes multi-user test scenarios, and automatically runs load testing. The method and system of the present invention supports a stateful model, i.e., messages can be built based on previous synchronization user sessions with the server, because information that is to be used in subsequent messages or user sessions is stored and updated in the configuration file. In another aspect of the present invention, security information is also stored in the configuration file so that the subthread can emulate secure communications between the virtual user and the server.

### BRIEF DESCRIPTION OF THE DRAWINGS

FIG. 1 illustrates a block diagram of a system for synchronizing data between a plurality of clients and a server.

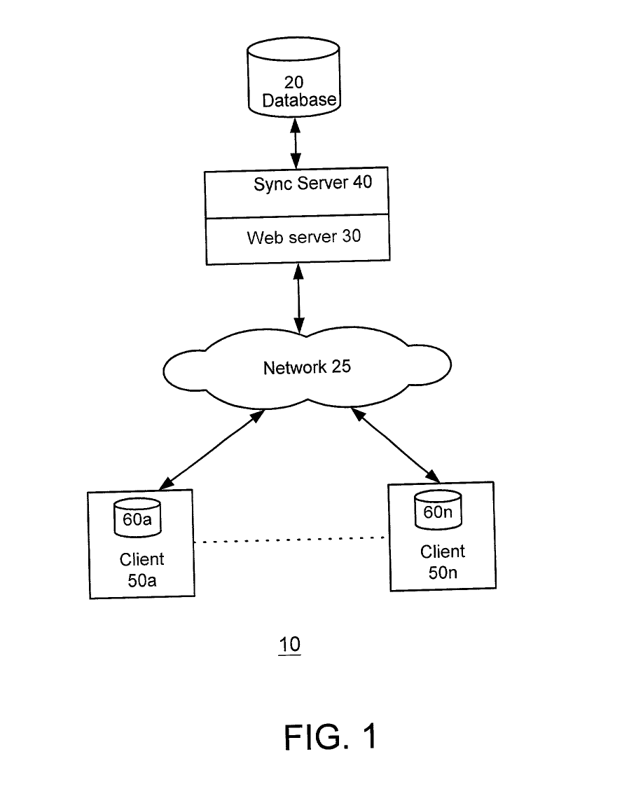

FIG. 2 illustrates a block diagram of a load testing system in accordance with a preferred embodiment of the present invention.

FIG. 3 is a block diagram of a virtual user in accordance with the present invention.

FIG. 4 is a flowchart for a load testing process in accordance with the present invention.

FIG. 5 is a flowchart illustrating the process of building a message in a user session in accordance with a preferred embodiment of the present invention.

### DETAILED DESCRIPTION

The present invention relates generally to computer systems and, more particularly, to a method and system for load testing a server. The following description is presented to enable one of ordinary skill in the art to make and use the invention and is provided in the context of a patent application and its requirements. For instance, while the preferred embodiment of the present invention will be described in the context of a sync server accessed by a plurality of thin devices, various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The method and system in accordance with a preferred embodiment of the present invention tests an entire enterprise infrastructure by emulating hundreds of clients, including mobile users, using real-time performance monitors to identify and isolate problems. It can simulate any synchronization scenario that a real client presents, such as a data store refresh, an upload of new adjustment form data to data sources in the enterprise, and a download of new adjustment form data onto the mobile device. In addition, it can provide emulation of any combination of synchronization scenarios. From the server's perspective, the server cannot differentiate between requests issued by the emulated clients from those issued by actual users.

In a preferred embodiment, a thread is utilized to emulate a plurality of user sessions. Utilizing a thread to emulate user sessions offers several advantages. For instance, because a thread is a path of execution within a process' code, it utilizes computer resources more efficiently than a script, which itself constitutes a process. One thread can spawn hundreds of user sessions using one process, while hundreds of scripts would have to be compiled in order to produce the same number of user sessions. Moreover, as those skilled in the art would appreciate, threads can be controlled and synchronized easily to simulate a concurrent load.

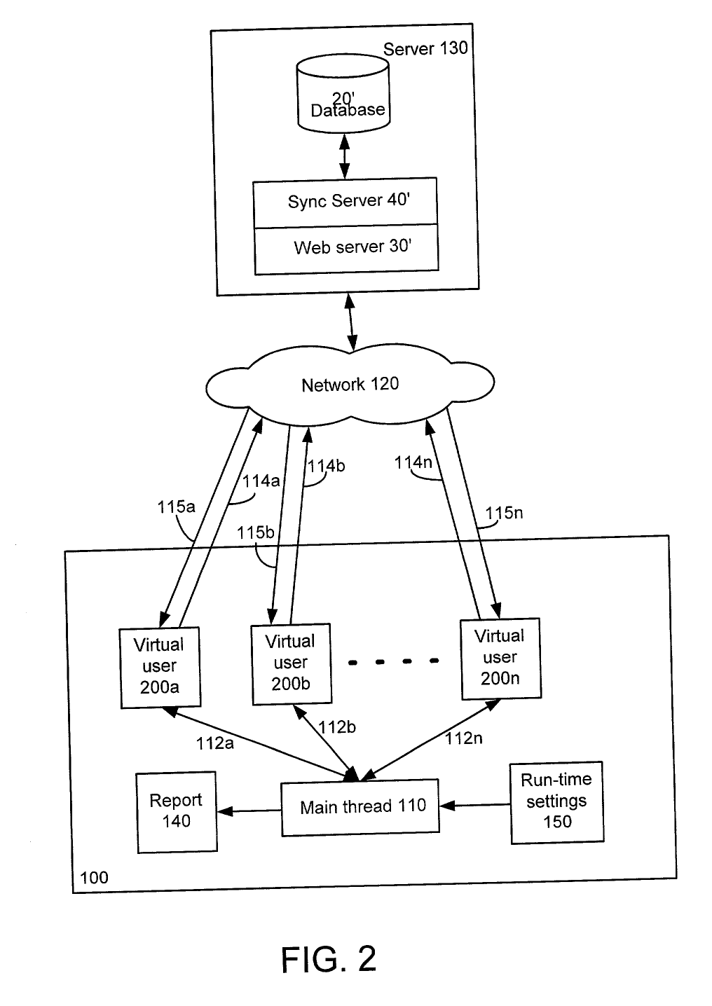

FIG. 2 illustrates a simple block diagram of the load tester system 100 in accordance with the preferred embodiment of the present invention. In a preferred embodiment, the load tester system 100 is coupled to the web server 30′, via a network 120, and runs on a standard desktop computer (not shown) with memory. The web server 30′ includes the sync server 40,′ which is in communication with the database 20.′ collectively, the web server 30′, sync server 40′ and database 20′ will be referred to simply as the server 130. The load test system 100 is preferably implemented in Java, and therefore platform independent.

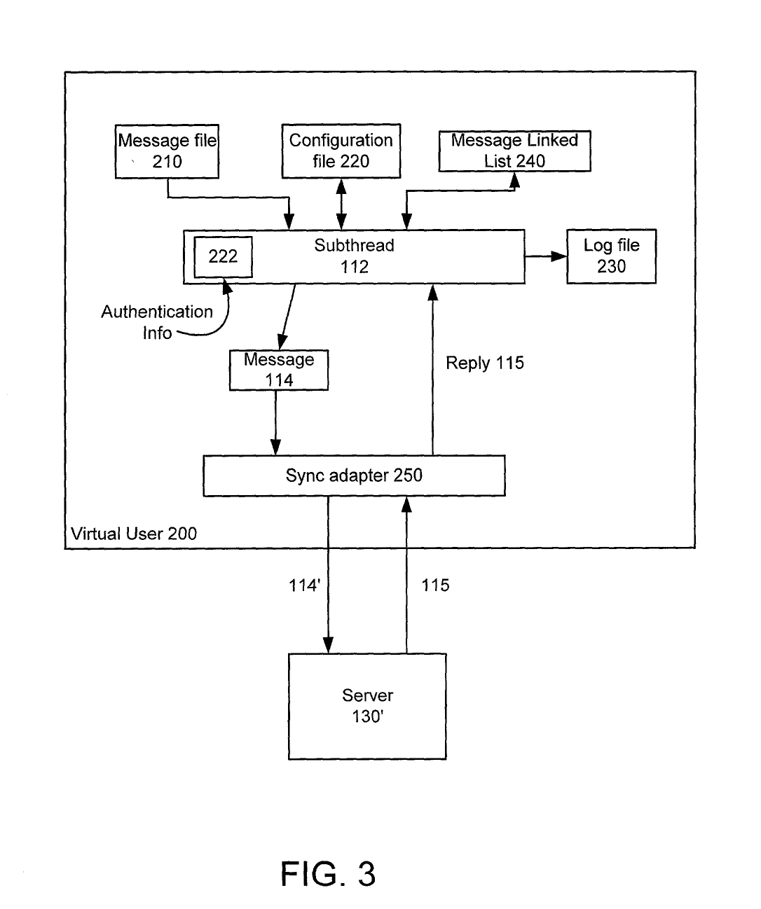

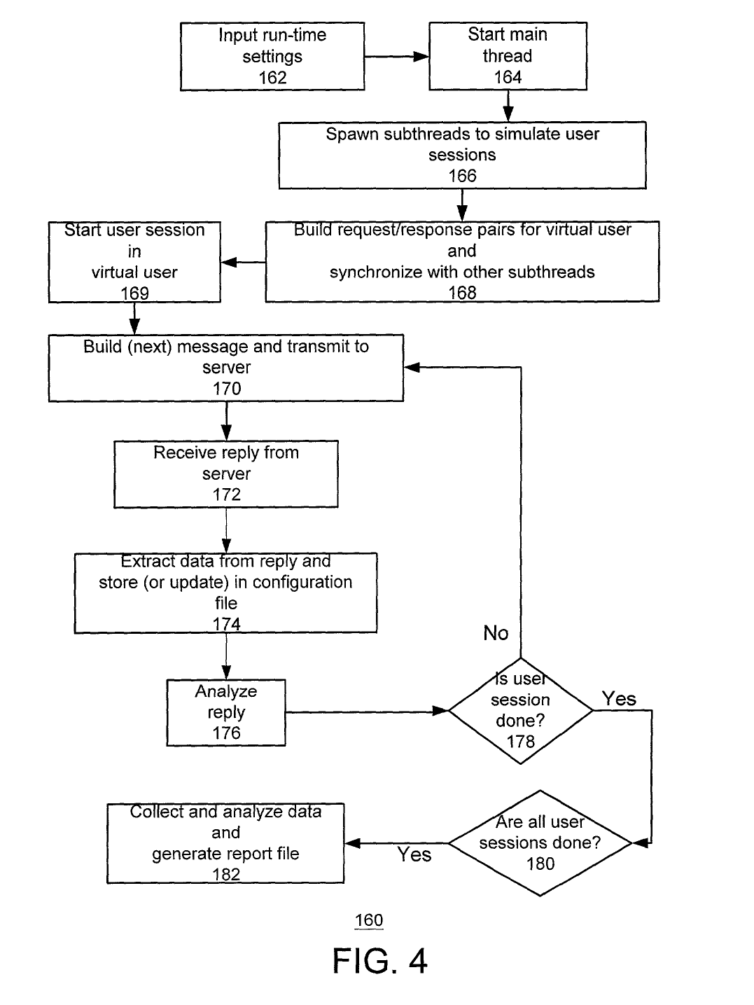

FIG. 3 illustrates a block diagram of a virtual user 200, and FIG. 4 is a flowchart illustrating a high level process 160 for load testing the server in accordance with the preferred embodiment of the present invention. As is shown in FIG. 4, the process begins at step 162 when run-time settings 150 are inputted by a tester. Run-time settings 150 include the number of virtual users desired, the type(s) of user session (s) to emulate, and other parameters that emulate the behavior of actual users. The tester may choose to emulate the same user session in all virtual users, or to emulate different user sessions in each of the virtual users. Examples of the other parameters include:

Think time: Controls the speed at which the virtual user interacts with the server by including pauses for think times during test execution. By varying think times for users, the behavior of different devices, e.g., PDAs and cell phones, can be emulated.

Time out: Allows virtual users to specify time out for network operation.

Network speed: Simulates the network speed of the client/server environment.

Number of retries: Defines the number of retries the virtual user can attempt after communication is interrupted or failed between the client and the server, e.g., because the user cannot get a reply from the server or the server does not receive the request from the client.

Stagger: Controls the speed at which the virtual users synchronize with the sync server by dictating how long to wait for the next user to begin synchronization after the previous one starts. The run-time settings 150 are used by a main thread 110 (FIG. 2) to create a test scenario.

Next, in step 164, the main thread 110 is started. In step 166, the main thread 110 spawns multiple subthreads 112a-112n (FIG. 2), each of which emulates a separate user session on a separate virtual user 200a-200n. Each subthread 112a-112n is independent of the other subthreads in order to simulate actual client devices.

As was mentioned above, thin devices have limited resources, and therefore, a user session typically involves at least one request from the user and at least one response from the server, referred to as a request/response pair. Accordingly, in step 168, for each virtual user 200 (FIG. 3), the subthread 112 builds at least one request/response pair that represents the request(s) from the virtual user 200 and the expected response(s) from the server 130′ during the user session. Once the request/response pairs have been built for the user session, the subthread 112 preferably waits until all other subthreads 112a- 112n have completed building their respective request/response pairs. By waiting, the subthreads 112a-112n synchronize with one another.

Once all of the subthreads 112a-112n have completed step 168, each subthread 112 begins its respective user session in step 169. The subthread 112 creates a message 114 that includes a first request, and transmits the message 114 to the server 130′ via a network 120 (FIG. 2) in step 170. Because the subthreads 112a-112n are synchronized before starting the user sessions (step 168), the timing of the transmission of the messages is controlled. In this manner, the load tester of the present invention can simulate concurrent user sessions or control the stagger time of a plurality of user sessions.

Referring again to FIG. 4, in step 172, the subthread 112 receives the server's reply 115. The subthread 112 then extracts from the reply 115 information that may be needed in subsequent messages in the user session and information that may be needed in subsequent user sessions, via step 174. This information is then stored, or updated if it already exists, in a configuration file 220 associated with the virtual user 200.

The purpose of storing and updating information in the configuration file 220 is to allow the method and system of the present invention to emulate secured communications between the virtual user 200 and the server 130′, as well as to incorporate information received in previous user sessions into a current user session, i.e. to support a stateful model. For example, during an emulated refresh user session, the reply 115 from the server can include state related information, such as database tables, table definitions and table schema, or other information pertaining to state related information. For example, the reply 115 from the server can include a subscription identification number that corresponds to the state related information for a database in the server. The state related information is stored in the configuration file 220 because a subsequent user session for synchronization cannot be emulated without this information. Similarly, because communications from the server may be secure, e.g., encrypted, the reply 115 may include security information, such as an encryption key. The security information is stored in the configuration file 220 because it is used in subsequent messages 114 transmitted by the virtual user to ensure secured communication with the server 130′.

In a preferred embodiment, the configuration file 220 can also store cookies transmitted by the server 130′ during load testing. Hence, the virtual user, like the actual user, is capable of receiving and transmitting cookies. In certain transactions, cookies are used to facilitate consecutive user requests during a user session, as well as secured communications. For example, during load balancing, each request during the user session is directed to the same server. In order to ensure proper routing, the server transmits a cookie containing information identifying itself to the user. The user can utilize this cookie to transmit subsequent requests to that server. Naturally, one skilled in the art would appreciate that cookies can and do serve numerous functions beyond those described herein.

Referring again to FIG. 4, after the subthread 112 has extracted the information for the configuration file 220, the subthread 112 analyzes the reply 115 in step 176. In a preferred embodiment, the subthread 112 compares the reply 115 to the expected response built in step 168. Results of the comparison are stored in a log file 230 associated with the virtual user 200. If more requests need to be transmitted, i.e., the user session is not finished (step 178), the subthread 112 repeats steps 170-176 in order to simulate the actual user session.

As was mentioned above, each subthread 112a-112n (FIG. 2) independently emulates a user session on its associated virtual user 200a-200n, and records testing information, such as response time, and flags problems associated with the user session. When each user session is finished, the associated subthread 112a-112n terminates. Once all user sessions have completed (step 180), the main thread 110 collects and analyzes the testing information from each subthread 112a- 112n, and generates a report file 140 in step 182. If the tester desires detailed information pertaining to a user session for a particular virtual user, the tester can examine the log file 230 associated with that virtual user.

It is important to note that when the user session is complete, the subthread 112 terminates. The virtual user 200 associated with that subthread 112, however, remains on account of its configuration file 220, which stores state related information and security information pertaining to the virtual user 200. Accordingly, the tester can run a subsequent user session, i.e. start another main thread 110, on the virtual user 200 to test various synchronization scenarios based on previous user sessions. If the tester wishes to redefine the virtual user 200, e.g., convert the virtual user from a PDA to a cellular phone, the tester need only emulate a refresh user session for the new device (cellular phone), whereby the server 130′ would transmit the appropriate information based on the message(s) 114 transmitted from the virtual user 200.

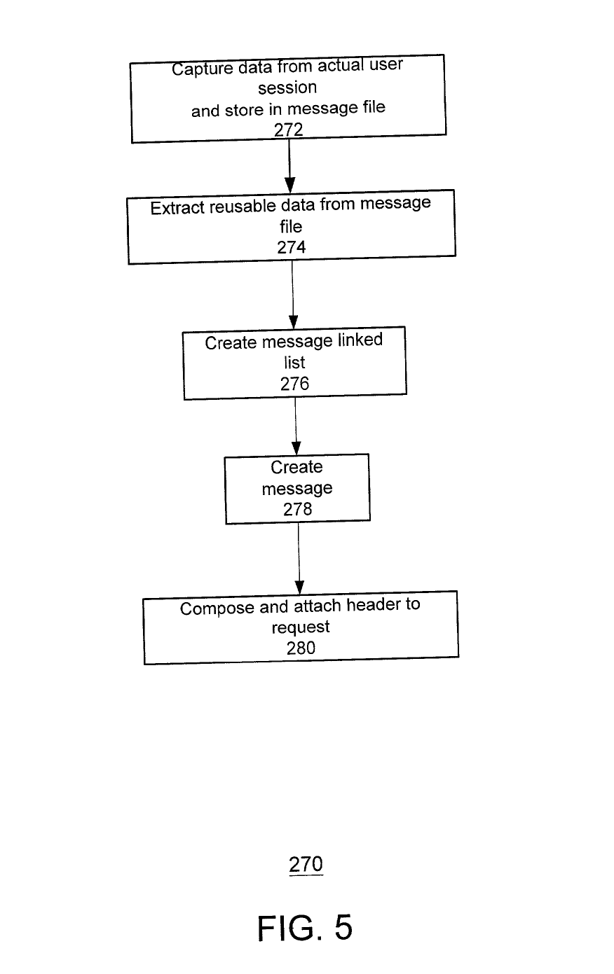

In the method and system of the present invention, the messages 114 transmitted from the virtual users 200 are the key to accurate and effective load testing. FIG. 5 is a flowchart illustrating a process 270 for building the messages 114 of a user session in accordance with the preferred embodiment of the present invention. As is shown in FIG. 5, the process begins by capturing data from a user session between an actual client device and the server 130′, and storing the captured data in a corresponding message file 210, via step 272. In a preferred embodiment, the tester records server traces for different transactions, such as refresh and synchronization transactions, performed by different client devices. The recorded traces serve as a source for the requests 114 transmitted by the virtual user 200. The recorded traces also provide recorded responses from the server 130′, which are then used by the subthread 112 to analyze the server's replies 115 to the emulated requests. In a preferred embodiment, only the reply's reusable data, i.e., the data that is not related to the user or user session, is compared to the recorded response.

Each type of recorded trace is stored in a separate message file 210. For clarity, FIG. 4 illustrates a message file 210 associated with the virtual user 200 because each virtual user 200 accesses a message file 210 to emulate a particular user session. One of ordinary skill in the art, however, would appreciate that the message files 210 could also reside in a directory accessible to all virtual users 200. In other words, the message files 210 can be a shared files stored on the computer system running the load tester system 100.

When the tester starts the load testing process, the main thread spawns the plurality of subthreads 112a-112n (step 166, FIG. 4). In each virtual user 200, the subthread 112 accesses the appropriate message file 210 that contains the server trace corresponding to the desired user session and extracts reusable data from the message file 210, via step 274. Reusable data refers to data that is independent of the user's identity or the user session. Reusable data includes, for example, the client's request to refresh, insert, delete, or update data in a database, the actual data the user would enter for such a request, and the actual data a user might receive from the server.

Next, in step 276, the subthread 112 creates a message linked list 240 (FIG. 3) by parsing the reusable data to extract the recorded request/response pairs making up the recorded user session. The message linked list 240 lists the recorded request/response pairs in the order that the requests were transmitted. The subthread 112 then takes the first recorded request on the linked list 240 and builds a message 114 that includes the virtual user's authentication information 222, via step 278. The authentication information 222 enables the subthread 112 to establish communication with the server 130.′

In certain circumstances, information stored in the configuration file 220 is also included in the message 114 in order to conduct secured communications or to perform a particular transaction, such as a synchronization operation. Once a sync adapter 250 composes and attaches a header to the message 114 in step 280, the message 114′ is ready to be transmitted to the server 130′.

By recording traces for different types of transactions (user sessions) and for different types of client devices, the method and system of the present invention can emulate a plethora of test scenarios without code modifications. For instance, by recording different server traces, such as traces for refresh, traces for uploading new adjustment form data to the sync server, and traces for downloading new adjustment form data from sync server onto the thin device, combined synchronization scenarios can be easily simulated.

Through aspects of the present invention, communications (requests and responses) exchanged between a client and a server are simulated by a thread. Because, the request/response pairs are not actually created and processed by each virtual user, the load tester system of the present invention can be designed lightly. Moreover because the load tester system relies primarily on the message file and configuration file to test various scenarios, the tester need only capture a new trace (and create a new message file) to run a new test.

The method and system of the present invention supports a stateful model, i.e., messages can be built based on previous synchronization user sessions with the server because state related information is stored in the configuration file. So, for example, the load tester system can emulate user sessions on clients utilizing a Mobile Data Synchronization Protocol (MDSP), which requires each client to have its own configuration settings, to remember which application it is subscribed to, which synchronization session it is processing, and which authentication id it has. All such information varies from one user to the next and can be different for the same user at different synchronization stages.

The method and system according to the preferred embodiment of the present invention easily creates a system load, quickly composes multi-user test scenarios, and automatically runs load testing. Minimal hardware and personnel resources are needed for testing because thousands of virtual users can be run on just a few computing systems. Once the load test is completed, the method and system of the present invention collects all test performance data and provides a sophisticated analysis and report.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for load testing a server, wherein the server is accessed by a plurality of client devices, the method comprising the steps of:
(a) providing at least one virtual user, wherein each of the at least one virtual users simulates one of the plurality of client devices;
(b) providing a main thread to emulate a plurality of user sessions between the at least one virtual user and the server, wherein each user session includes at least one request/response pair;
(c) generating a plurality of subthreads from the main thread, wherein each subthread emulates one of the plurality of user sessions;
(d) building in each virtual user a message, wherein the message includes a request extracted from the at least one request/response pair in the one user session; and
(e) transmitting the message to the server.

2. The method of claim 1 further including the step of:
(f) synchronizing each of the at least one virtual users to one another prior to the transmitting step (e).

3. The method of claim I further including the steps of:
(f) receiving a reply from the server;
(g) extracting, from the reply, information that is to be used in subsequent messages, wherein the information includes any combination of state related information, cookies, and security information; and
(h)storing the extracted information in a configuration file associated with the virtual user.

4. The method of claim 3 further including the steps of:
(i) repeating steps (d) through (h) until each request of the user session has been transmitted; and
(j) updating the stored information in the configuration file.

5. The method of claim 1, wherein the building step (d) includes the steps of:
(d1) capturing data from a real time user session between a client device and the server, wherein the captured data includes the at least one request/response pair of the user session; and
(d2) composing the message from the captured data and information stored in a configuration file associated with the virtual user, wherein the stored information includes any combination of state related information, cookies, and security information.

6. The method of claim 5, wherein the capturing step (d1) further includes the step of:
(d1i) recording a server trace of the user session.

7. The method of claim 5, wherein the building step (d) further including the steps of:
(d3) storing the captured data in a message file;
(d4) parsing reusable data from the message file, wherein the reusable data includes the at least one request/response pair of the user session; and
(d5) providing authentication information for the virtual user including user identification and password;
wherein the message further includes the authentication information and a portion of the reusable data from the message file.

8. The method of claim 5, wherein the building step (d) further includes the step of:
(d3) creating a message linked list to store the at least one request/response pair of the user session.

9. The method of claim 1 further including the steps of:
(f) receiving a reply from the server;
(g) comparing the reply with an expected response; and
(h) recording a result of the comparison in a log file associated with the virtual user.

10. The method of claim 9, wherein the expected response is a recorded response from a trace of the user session.

11. The method of claim 9 further including the steps of:
(i) repeating steps (d) through (h) until each request in the user session is completed; and
(j) generating a report file, wherein the report file includes load testing information regarding server throughput and total response time.

12. The method of claim 1 further including the step of:
(f) inputting run-time settings to emulate behavior of a client device, wherein the run-time settings include, think time, time out, network speed, and stagger time.

13. A computer readable medium containing programming instructions for load testing a server, wherein the server is accessed by a plurality of client devices, comprising the instructions for:
(a) providing at least one virtual user, wherein each of the at least one virtual users simulates one of the plurality of client devices;
(b) providing a main thread to emulate a plurality of user sessions between the at least one virtual user and the server, wherein each user session includes at least one request/response pair;
(c) generating a plurality of subthreads from the main thread, wherein each subthread emulates one of the plurality of user sessions;
(d) building in each virtual user a message, wherein the message includes a request extracted from the at least one request/response pair in the one user session; and
(e) transmitting the message to the server.

14. The computer readable medium of claim 13 further including the instructions for:
(f) synchronizing each of the at least one virtual users to one another prior to the transmitting instruction (e).

15. The computer readable medium of claim 13 further including the instructions for:
(f) receiving a reply from the server;
(g) extracting, from the reply, information that is to be used in subsequent messages, wherein the information includes any combination of state related information, cookies, and security information; and
(h) storing the extracted information in a configuration file associated with the virtual user.

16. The computer readable medium of claim 15 further including the instructions for:
(i) repeating steps (d) through (h) until each request of the user session has been transmitted; and
(j) updating the stored information in the configuration file.

17. The computer readable medium of claim 13, wherein the building instruction (d) includes the instructions for:
(d1) capturing data from a real time user session between a client device and the server, wherein the captured data includes the at least one request/response pair of the user session; and
(d2) composing the message from the captured data and information stored in a configuration file associated with the virtual user, wherein the stored information includes any combination of state related information, cookies, and security information.

18. The computer readable medium of claim 17, wherein the capturing instruction (d1) further includes the instruction for:
(d1i) recording a server trace of the user session.

19. The computer readable medium of claim 17, wherein the building instruction (d) further including the instructions for:
(d3) storing the captured data in a message file;
(d4) parsing reusable data from the message file, wherein the reusable data includes the at least one request/response pair of the user session; and
(d5) providing authentication information for the virtual user including user identification and password;
wherein the message further includes the authentication information and a portion of the reusable data from the message file.

20. The computer readable medium of claim 17, wherein the building instruction (d) further includes the instruction for:
(d3) creating a message linked list to store the at least one request/response pair of the user session.

21. The computer readable medium of claim 13 further including the instructions for:
(f) receiving a reply from the server;
(g) comparing the reply with an expected response; and
(h) recording a result of the comparison in a log file associated with the virtual user.

22. The computer readable medium of claim 21, wherein the expected response is a recorded response from a trace of the user session.

23. The computer readable medium of claim 21 further including the instructions for:
(i) repeating steps (d) through (h) until each request in the user session is completed; and
(j) generating a report file, wherein the report file includes load testing information regarding server throughput and total response time.

24. The computer readable medium of claim 13 further including the instruction for:
(f) inputting run-time settings to emulate behavior of a client device, wherein the run-time settings include, think time, time out, network speed, and stagger time.

25. A system for load testing a server, wherein the server is accessed by a plurality of client devices, the system comprising:
a computer system including a processor for executing a programming application; and
memory coupled to the processor;
wherein the programming application:
provides at least one virtual user, wherein each of the at least one virtual users simulates one of the plurality of client devices;
provides a main thread to emulate a plurality of user sessions between the at least one virtual user and the server, wherein each user session includes at least one request/response pair;
generates a plurality of subthreads from the main thread, wherein each subthread emulates one of the plurality of user sessions;
builds, in each virtual user, a message, wherein the message includes a request extracted from the at least one request/response pair in the one user session; and
transmits the message to the server.

26. The system of claim 25 further including means for synchronizing each of the at least one virtual users to one another prior to the transmitting the message.

27. The system of claim 25 further including:
means for receiving a reply from the server;
wherein the programming application further:
extracts, from the reply, information that is to be used in subsequent messages, wherein the information includes any combination of state related information, cookies, and security information;
stores in the memory the extracted information in a configuration file associated with the virtual user; and
updates the information stored in the configuration file.

28. The system of claim 25 further including:
means for capturing data from a real time user session between a client device and the server, wherein the captured data includes the at least one request/response pair of the user session, wherein the programming application composes the message from the captured data and information stored in a configuration file associated with the virtual user, wherein the information includes any combination of state related information, cookies, and security information.

29. The system of claim 25, wherein the programming application provides authentication information for the virtual user including user identification and password.

30. The system of claim 25 further including:
means for receiving a reply from the server;
wherein the programming application further compares the reply with an expected response and records a result of the comparison in memory in a log file associated with the virtual user.

31. The system of claim 25, wherein, after each user session has been emulated, the programming application further generates a report file , wherein the report file includes load testing information regarding server throughput and total response time.

32. The system of claim 25 further including:
means for inputting run-time settings to emulate behavior of a client device, wherein the run-time settings include, think time, time out, network speed, and stagger time.

33. A method for load testing a server, wherein the server is accessed by a plurality of client devices, the method comprising the steps of:
(a) providing at least one virtual user, wherein each of the at least one virtual users simulates one of the plurality of client devices;
(b) providing a main thread to emulate a plurality of user sessions between the at least one virtual user and the server, wherein each user session includes at least one request/response pair;
(c) generating a plurality of subthreads from the main thread, wherein each subthread emulates one of the plurality of user sessions;
(d) providing, in each virtual user, a configuration file for storing information that is to be used in subsequent and current messages;
(e) building, in each virtual user, a message, wherein the message includes a request extracted from the at least one request/response pair in the one user session and configuration file information; and
(f) transmitting the message to the server.

34. The method of claim 33 further including the steps of:
(g) receiving a reply from the server;
(h) extracting, from the reply, configuration file information, wherein the information includes any combination of state related information, cookies, and security information; and
(i) storing the extracted information in the configuration file associated with the virtual user.

35. The method of claim 34 further including the steps of:
(j) comparing the reply with an expected response;
(k) recording a result of the comparison in a log file associated with the virtual user;
(l) repeating steps (e) through (k) until each request in the user session is completed; and
(m) generating a report file based on the log file for each virtual user, wherein the report file includes load testing information regarding server throughput and total response time.

36. A computer readable medium containing programming instructions for load testing a server, wherein the server is accessed by a plurality of client devices, comprising the programming instructions for:
(a) providing at least one virtual user, wherein each of the at least one virtual users simulates one of the plurality of client devices;
(b) providing a main thread to emulate a plurality of user sessions between the at least one virtual user and the server, wherein each user session includes at least one request/response pair;
(c) generating a plurality of subthreads from the main thread, wherein each subthread emulates one of the plurality of user sessions;
(d) providing, in each virtual user, a configuration file for storing information that is to be used in subsequent and current messages;
(e) building, in each virtual user, a message, wherein the message includes a request extracted from the at least one request/response pair in the one user session and configuration file information; and
(f) transmitting the message to the server.

37. The computer readable medium of claim 36 further including the instructions for:
(g) receiving a reply from the server;
(h) extracting, from the reply, configuration file information, wherein the information includes any combination of state related information, cookies, and security information; and
(i) storing the extracted information in the configuration file associated with the virtual user.

38. The computer readable medium of claim 37 further including the instructions for:
(j) comparing the reply with an expected response;
(k) recording a result of the comparison in a log file associated with the virtual user;
(l) repeating steps (e) through (k) until each request in the user session is completed; and
(m) generating a report file based on the log file for each virtual user, wherein the report file includes load testing information regarding server throughput and total response time.
